(19) United States
(12) Patent Application Publication
(10) Pub. No.: US 2008/0151359 A1
(43) Pub. Date: Jun. 26, 2008

(54) OPTICAL TRANSMISSION SYSTEM AND SIGNAL SPECTRUM CORRECTION METHOD

(76) Inventor: FUMISATO YOSHIDA, Tokyo (JP)

Correspondence Address: NEC CORPORATION OF AMERICA, 6535 N. STATE HWY 161, IRVING, TX, 75039, US

(21) Appl. No.: 11/954,563

(22) Filed: Dec. 12, 2007

(30) Foreign Application Priority Data
Dec. 20, 2006 (JP) 342027/2006

(51) Int. Cl. H01S 3/30

(52) U.S. Cl. 359/334

(57) ABSTRACT

An exemplary aspect of the invention is an optical transmission system including a Raman amplifier, wherein the Raman amplifier corrects the gain of a light signal by excitation light including light of at least one wavelength that reduces difference between a minimum value and a maximum value of the power spectral distribution of the input light signal.

This application is based upon and claims the benefit of priority from Japanese Patent Application No. 2006-342027 filed on Dec. 20, 2006, the contents of which are incorporated by reference.

### BACKGROUND OF THE INVENTION

1. Field of the Invention

The present invention relates to an optical transmission system and its signal spectrum correction method, particularly relates to a signal spectrum correction method in an optical transmission system using a Raman amplifier.

2. Description of the Related Art

To correspond to a demand of communication that rapidly increases according to the population of the Internet, the transmission capacity of an optical transmission system configuring a basic communication network recently increases at surprising speed. To correspond to such rapid increase of the capacity, optical wavelength division multiplexing technology, that is, wavelength division multiplexing (WDM) technology is established and the increase of the capacity of transmitted data is realized.

However, in a long-distance transmission system, the extension of a relay interval is a difficult objective together with the increase of transmission capacity. Then, to secure signal-to-noise power ratio (SN ratio) per one wave and to reduce the distortion of a transmission waveform by optical fiber non-linear effect, a transmission method that is called Raman amplification and that negates the loss of a transmission line has been proposed (for example, refer to Japanese Patent Laid-open Application Publication No. 2002-344054). Referring to FIG. 11, the related art using a Raman amplifier will be described below.

As shown in FIG. 11, the output of an optical transmitter 10 is amplified by a light amplifier (an erbium doped fiber amplifier (EDFA)) on the transmitting side 20 and is inputted to a Raman amplifier 40 via an optical fiber transmission line 30. The output of amplification by the Raman amplifier 40 is amplified by a light amplifier (EDFA) on the receiving side 50 and is received by an optical receiver 60.

FIG. 12 shows a signal spectrum at an output point “a” of the optical transmitter 10; and in this example, a wavelength division multiplexed wave of 40 waves in a signal band of 1574 to 1610 nm is shown. The output of the transmitter is made incident into the light amplifier on the transmitting side 20 and is amplified there. FIG. 13 shows a signal spectrum at an output point “b” of the light amplifier on the transmitting side 20. As the light amplifier 20 is provided with a gain equalization function, the flat signal spectrum is acquired at the output point “b”.

The output of the light amplifier 20 is inputted to the optical fiber transmission line 30, however, the transmission line 30 is a dispersion shifted fiber (DSF) including the transmission loss of 35 dB. A reference numeral 141 in FIG. 14 shows a signal spectrum at a point “c” of the output of amplification by the Raman amplifier 40, and the signal spectrum is amplified by 6.5 dB by Raman excitation light output from the Raman amplifier 40. The Raman amplifier 40 is provided with a flat gain characteristic because the signal spectrum at the output point “b” of the light amplifier on the transmitting side 20 has a flat characteristic as shown in FIG. 13. A reference numeral 142 in FIG. 14 shows a signal spectrum without Raman amplification.

The output of the Raman amplifier is inputted to the light amplifier on the receiving side 50 and is amplified there. FIG. 15 shows a signal spectrum at an output point “d” of the light amplifier 50. As the light amplifier 50 is provided with a gain equalization function, the flat signal spectrum in a signal band of 1574 to 1610 nm is acquired at the output point “d” and is inputted to the optical receiver 60. The light amplifier 50 is also an auto-level control (ALC) amplifier that keeps output power fixed.

FIG. 16 shows optical characteristics (a gain flatness characteristic and a noise figure (NF) characteristic) of the light amplifier 50. A reference numeral 161 shows the gain characteristic, 162 shows the NF characteristic, the characteristics are those in the case of long-distance transmission in configuration shown in FIG. 11, gain flatness is 0 dB, and an NF value is 11.2 dB.

In the configuration shown in FIG. 11 and using a Raman amplification method used for a long-distance transmission system according to the related art, to remove the dependency on a wavelength of a signal spectrum, a high-priced gain equalizer is required to be used for both the light amplifier on the transmitting side 20 and the light amplifier on the receiving side 50. When the gain equalizer is used for only the light amplifier on the receiving side 50, the dependency on a wavelength of a spectrum of a signal input to the light amplifier on the receiving side 50 increases. Therefore, there is caused a problem that the increase of the loss of the gain equalizer, the deterioration of the NF characteristic and the difficulty of the manufacture of the gain equalizer are caused and its price rises.

The art disclosed in Japanese Patent Laid-open Application Publication No. 2002-344054 has a defect that a signal spectrum is flattened in only the Raman amplifier, therefore, a high-performance characteristic is required for the Raman amplifier and its price rises.

### SUMMARY

An exemplary object of the invention is to provide an optical transmission system that can be low-priced and can avoid the deterioration of an NF characteristic and its signal spectrum correction method.

An exemplary aspect of the invention is an optical transmission system including a Raman amplifier, wherein the Raman amplifier corrects the gain of a light signal by excitation light including light of at least one wavelength that reduces difference between a minimum value and a maximum value of the power spectral distribution of the input light signal.

### BRIEF DESCRIPTION OF THE DRAWINGS

FIG. 1 is a block diagram showing a first exemplary embodiment of the invention;

FIG. 2 shows a signal spectrum at a point A;

FIG. 3 shows a signal spectrum at a point B;

FIG. 4 shows a signal spectrum at a point C;

FIG. 5 shows a gain characteristic of a Raman amplifier in comparison with that in related art;

FIG. 6 is a sequence diagram showing a signal spectrum at a point D;

FIG. 7 shows again characteristic of a receiving light amplifier 5 in comparison with that in the related art;

FIG. 8 shows an NF characteristic of the receiving light amplifier 5 in comparison with that in the related art;

FIG. 9 is a block diagram showing a second exemplary embodiment of the invention;

FIG. 10 is a block diagram showing an integrated light amplifier;

FIG. 11 is a block diagram for explaining the related art;

FIG. 12 shows a signal spectrum at a point a;

FIG. 13 shows a signal spectrum at a point b;

FIG. 14 shows a signal spectrum at a point c;

FIG. 15 shows a signal spectrum at a point d; and

FIG. 16 shows a gain characteristic and an NF characteristic of a light amplifier on the receiving side 50.

### DETAILED DESCRIPTION OF EXEMPLARY EMBODIMENTS

### 1. First Exemplary Embodiment

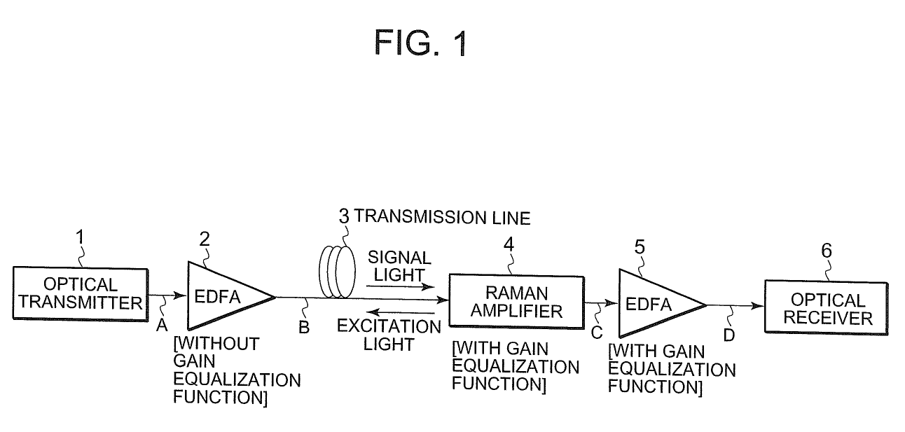

Referring to the drawings, an exemplary embodiment of the invention will be described below. FIG. 1 shows an optical transmission system using Raman amplification as a first exemplary embodiment of the invention. As shown in FIG. 1, a light amplifier (a booster amplifier) on the transmitting side 2 is arranged at the back of an optical transmitter 1 and is used for amplifying transmitted light power. A Raman amplifier 4 brings about signal gain in a wavelength band by making intense excitation light incident into an optical fiber as a transmission line 3 and uses the transmission line fiber itself for an amplification medium.

A light amplifier (a preamplifier) on the receiving side 5 is arranged in front of an optical receiver 6 and is used for improving receiving sensitivity. The light amplifiers 2 and 5 makes signal light and excitation light incident into the optical fiber into which a rare earth element is doped and amplify the signal light. However, the light amplifier 2 is not provided with a gain equalizer including a profile opposite to the dependency on a wavelength of the gain of the light amplifier and the light amplifier 5 is provided with a gain equalizer.

As the light amplifiers 2 and 5 are well-known for persons skilled in the art and besides, are not directly related to the invention, their detailed configuration is omitted. Further, as the Raman amplifier 4 is also well-known for the persons skilled in the art and is not directly related to the invention except the selection described later of an excitation wavelength, its detailed configuration is omitted.

In the configuration of the first exemplary embodiment, it is general that the light amplifiers 2 and 5 amplify signal light by making the signal light and excitation light incident into a core of the optical fiber including the rare earth element; however, they may also have configuration that light is amplified by multi-mode excitation for amplifying signal light by using a double-clad fiber for an optical fiber including a rare earth element and making excitation light incident into a second-clad part.

Next, the operation of the first exemplary embodiment of the invention will be described in detail. In this exemplary embodiment, as in the case of the related art, 40 waves in a signal band of 1574 to 1610 nm are also multiplexed into a WDM wave.

Wavelength division multiplexed signal light output from the optical transmitter 1 is amplified in the light amplifier 2 without a gain equalizer and is outputted to the transmission line 3 with the signal light including the dependency on a wavelength of a few dB. On the transmission line 3, amplification is acquired in a waveband longer by approximately 100 nm (13 THz) than the wavelength of excitation light in stimulated emission based upon Raman scattering by Raman excitation light output from the Raman amplifier 4, and the gain of an output spectrum including the dependency on a wavelength of a few dB is corrected. Afterward, the signal is again amplified in the light amplifier 5 provided with the gain equalizer and is inputted to the optical receiver 6 in a condition of a flat signal spectrum.

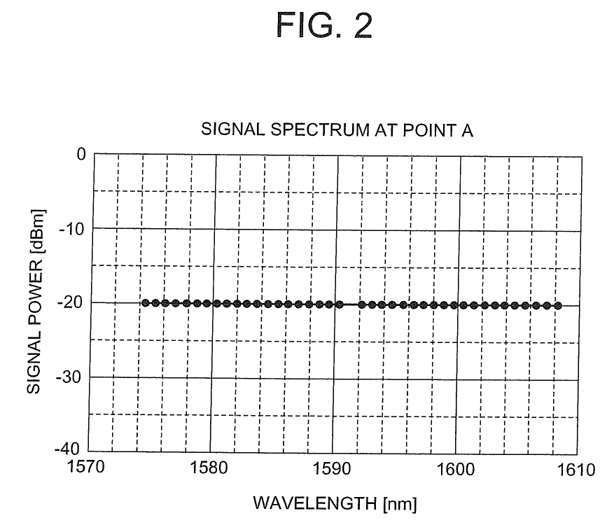

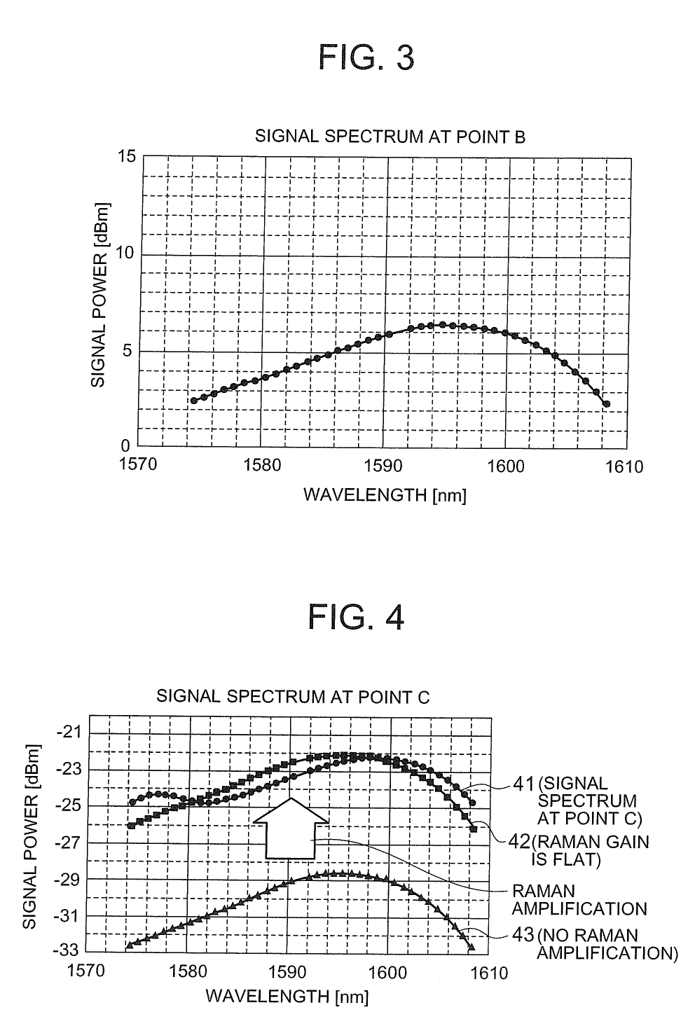

FIG. 2 shows a signal spectrum at an output point A of the optical transmitter 1. An input signal including the signal spectrum shown in FIG. 2 is incident into the light amplifier 2. FIG. 3 shows a signal spectrum at an output point B of the light amplifier on the transmitting side 2. The signal spectrum shown in FIG. 2 is amplified in the light amplifier 2 without a gain equalizer to be a signal spectrum including the dependency on a wavelength of 4.0 dB as shown in FIG. 3 and is outputted.

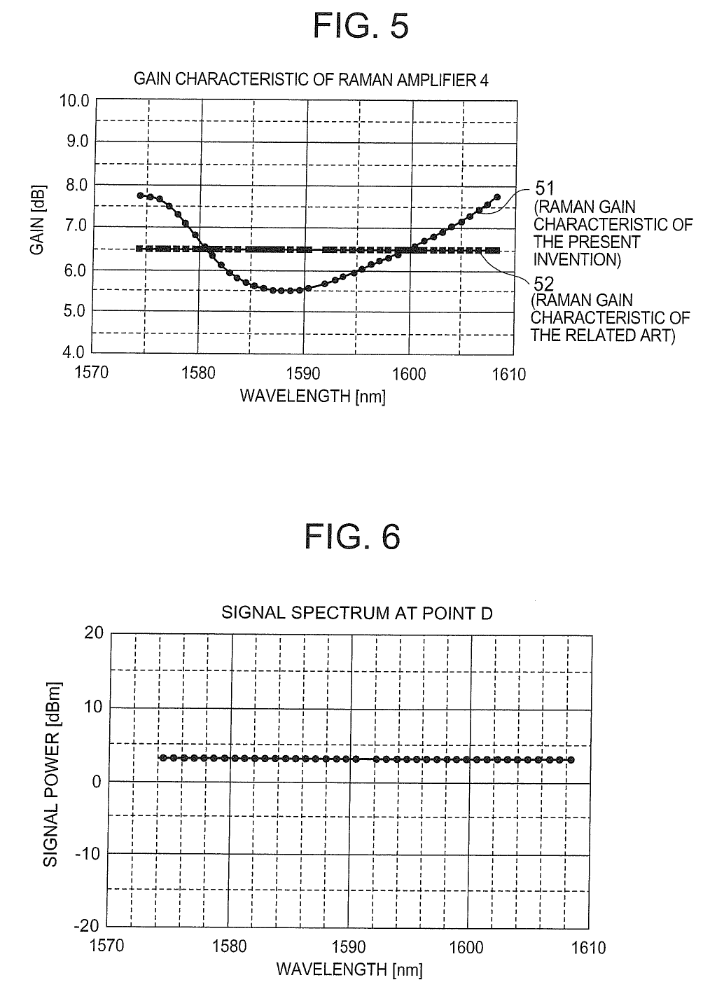

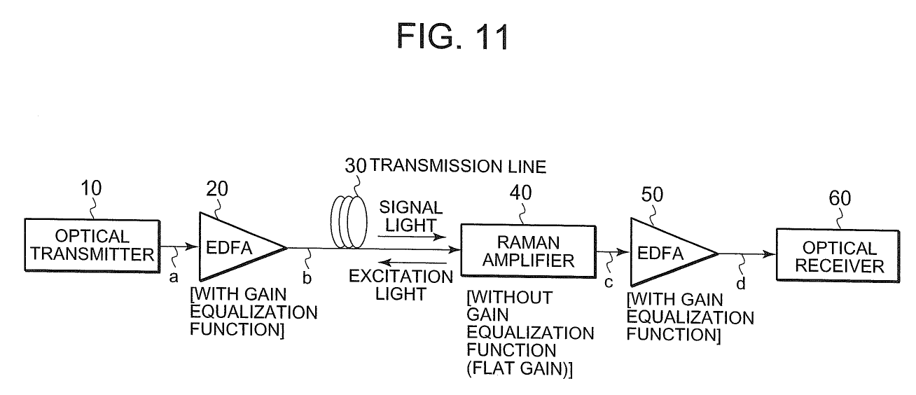

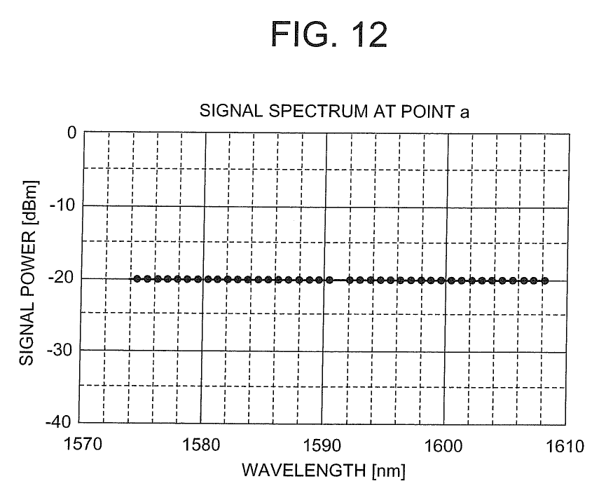

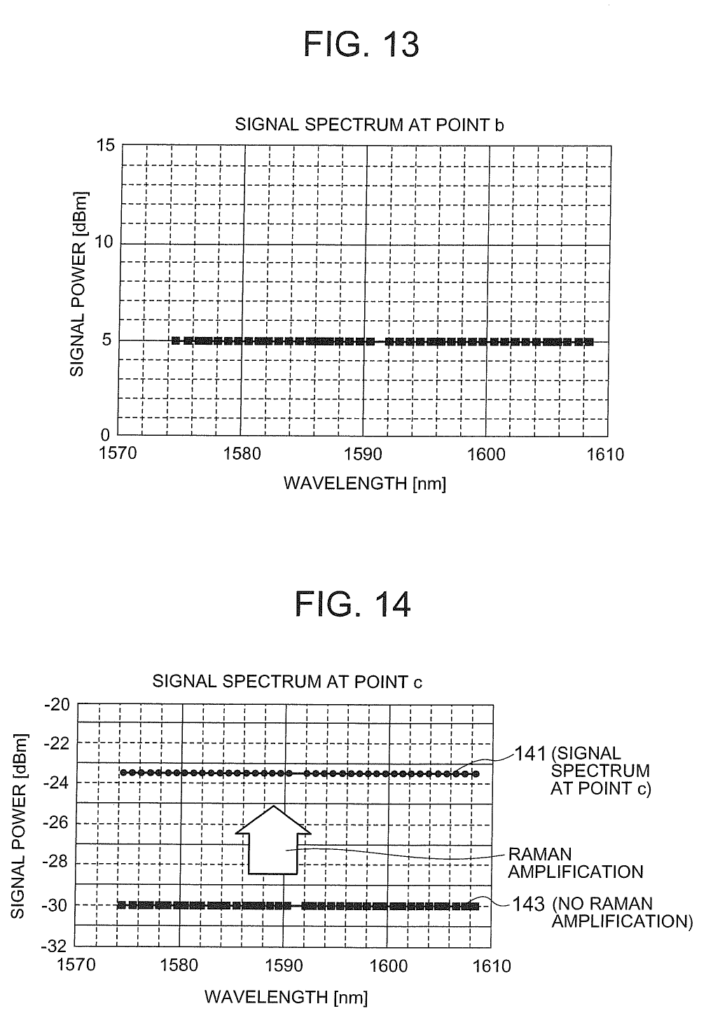

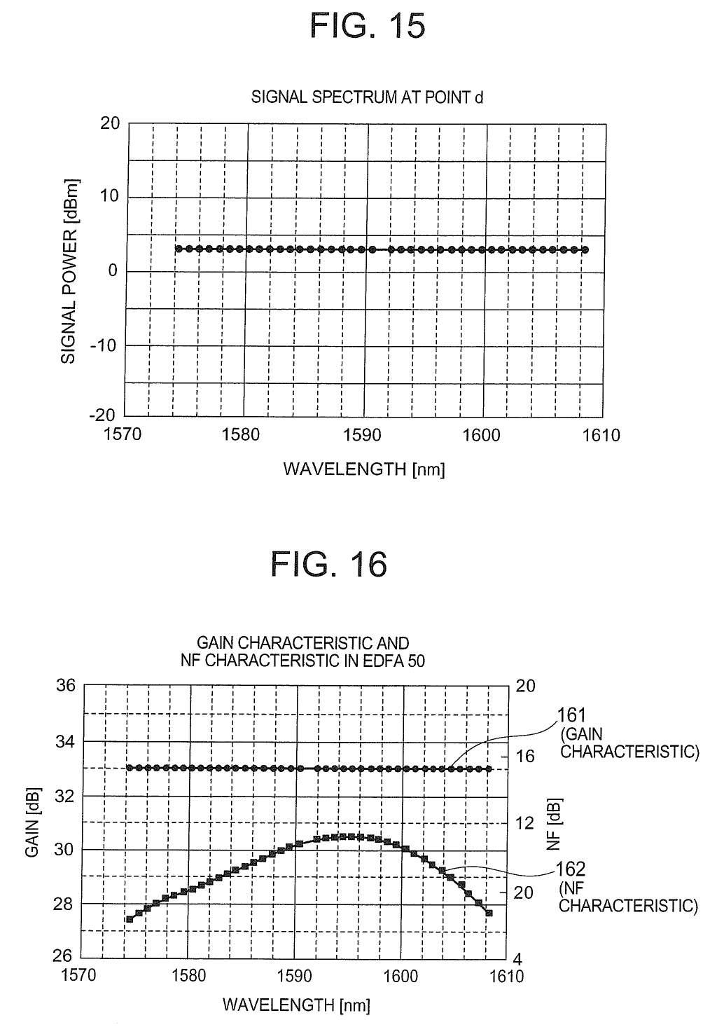

A DSF fiber 3 including the loss on a transmission line of 35 dB is estimated from the point B to a point C. FIG. 4 shows a signal spectrum at the point C. For the wavelength of Raman excitation light output from the Raman amplifier 4, 1462 nm and 1505 nm are selected and the signal spectrum 41 shown in FIG. 4 is an input signal spectrum to the light amplifier 5 acquired when the gain is corrected in the Raman amplifier. A spectrum of Raman gain acquired on the transmission line 3 at this time is shown by a reference numeral 51 in FIG. 5. A reference numeral 52 in FIG. 5 shows a spectrum of Raman gain in the related art described referring to FIG. 11.

A signal spectrum 42 shown in FIG. 4 is an input signal spectrum to the light amplifier 5 when the signal is amplified so that Raman gain is flat in the Raman amplifier 4 (when no gain is corrected in the Raman amplifier). Raman gain acquired by the Raman amplifier 4 is 6.5 dB on the average. Further, an input signal spectrum to the light amplifier 5 when no Raman amplification is made is shown as a signal spectrum 43 for reference data.

FIG. 6 shows a signal spectrum at an output point D of the light amplifier on the receiving side 5. The signal spectrum shown in FIG. 6 is an output signal spectrum after the signal spectrum 41 shown in FIG. 4 is amplified by the light amplifier 5. The light amplifier 5 is an ALC control amplifier that keeps output power fixed and the flat signal spectrum in the signal band of 1574 to 1610 nm is inputted to the optical receiver 6.

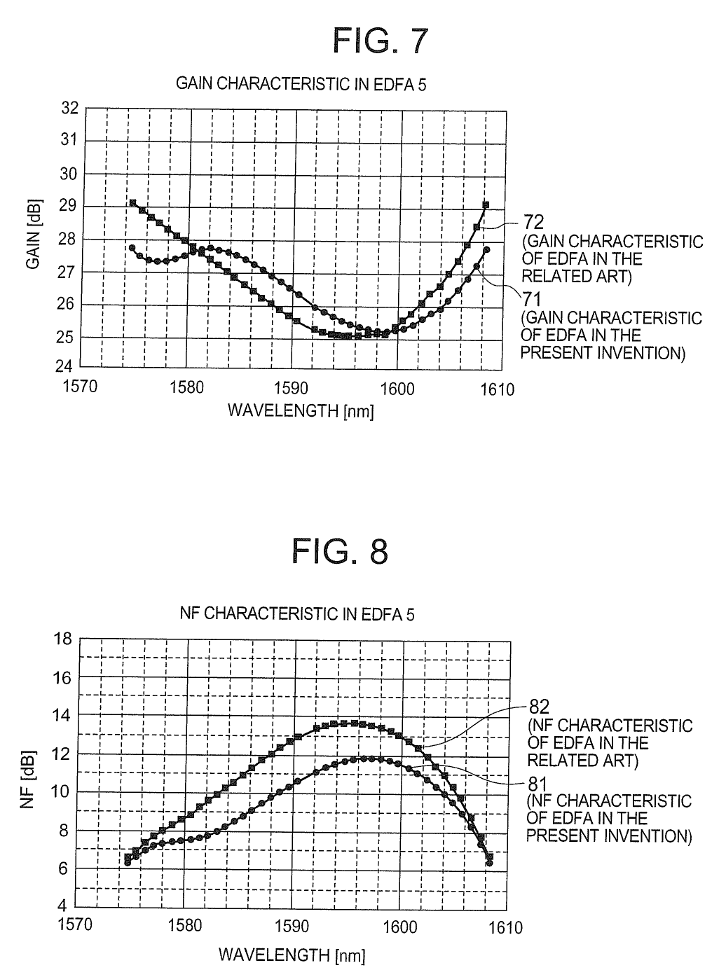

Optical characteristics (a gain flatness characteristic and an NF characteristic) in the light amplifier 5 are shown in FIGS. 7 and 8 in comparison with those in the related art shown in FIG. 11. A gain spectrum 72 and the NF characteristic 82 are optical characteristics in a light amplifier on the receiving side when no gain is corrected by a Raman amplifier in long-distance transmission in the related art shown in FIG. 11, gain flatness is 4.0 dB, and an NF value is 13.6 dB.

In the meantime, a gain spectrum 71 and the NF characteristic 81 are optical characteristics in the light amplifier 5 on the receiving side when gain is corrected in the Raman amplifier 4 according to the invention in long-distance transmission in the configuration according to the invention shown in FIG. 1, gain flatness is 2.5 dB, and an NF value is 11.8 dB. It is known from this result that the flatness of a signal spectrum input to the light amplifier on the receiving side 5 after the transmission line is improved by correcting gain in the Raman amplifier, a maximum loss characteristic of the gain equalizer in the light amplifier on the receiving side 5 is reduced and the NF characteristic of the light amplifier 5 is improved by 1.8 dB.

### 2. Second Exemplary Embodiment

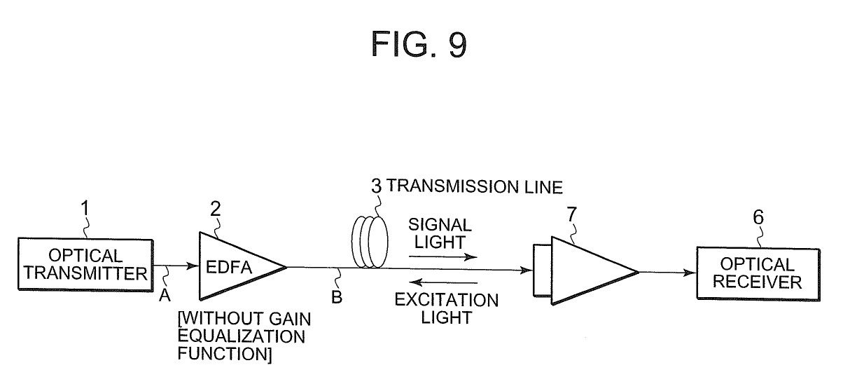

The basic configuration of a second exemplary embodiment of the invention is similar to that of the first exemplary embodiment; however, the configuration of a light amplifier on the receiving side is further devised. FIG. 9 shows the configuration. In FIG. 9, the same reference numeral is allocated to the similar part to that shown in FIG. 1. As shown in FIG. 9, the Raman amplifier 4 and the light amplifier on the receiving side 5 respectively shown in FIG. 1 are integrated to be an integrated light amplifier 7, and a signal light input monitor in the Raman amplifier and a signal light input monitor in the light amplifier on the receiving side are made common. Hereby, the price of the light amplifier on the receiving side can further be reduced.

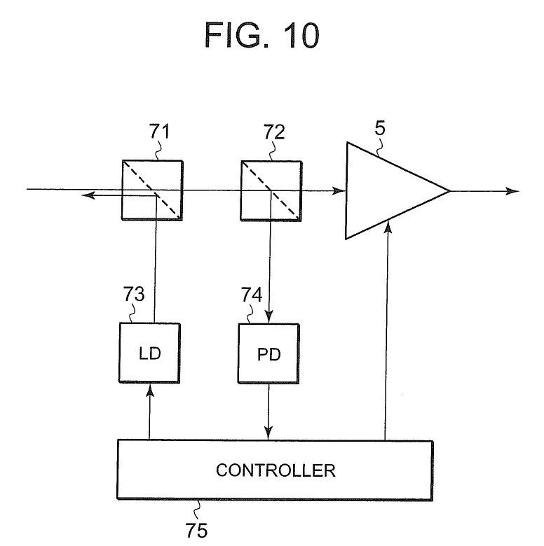

Referring to FIG. 10, the details of the integrated light amplifier 7 will be described below. An exciting laser diode (LD) 73 is a Raman pumping source and amplifies signal light using Raman effect on the transmission line 3. An exciting WDM coupler 71 multiplexes signal light and excitation light, the excitation light is multiplexed in a reverse direction to the signal light, and is outputted to the transmission line 3.

A demultiplexing coupler 72 demultiplexes input signal light at certain ratio and a photodiode (PD) 74 receives a light signal and converts it to an electric signal. As a light amplifier 5 is well-known for persons skilled in the art, its detailed configuration is omitted. Signal power input to the integrated light amplifier 7 is received by PD 74, and according to received output, the exciting LD 73 as a Raman pumping source and a pumping source in the light amplifier 5 are controlled by a controller 75. As a transmitted state of a wavelength division multiplexed signal in FIG. 9 is described above, the description of the state is omitted.

As described above, as the signal light input monitor in the Raman amplifier and the signal light input monitor in the light amplifier on the receiving side are made common in the second exemplary embodiment, the price of the light amplifier on the receiving side can be reduced.

As described above, in the invention, loss in a gain equalizer used in the light amplifier on the receiving side is reduced by providing no gain equalization function to a light amplifier on the transmitting side, correcting a gain characteristic of a signal spectrum by providing no gain equalization function to the light amplifier on the transmitting side using a Raman amplifier, inputting the signal spectrum to the light amplifier on the receiving side with as a flat characteristic as possible and finally, also correcting gain in the light amplifier on the receiving side in comparison with a case that a signal spectrum is inputted to a light amplifier on the receiving side using a normal Raman amplifier (without a gain correction function), and an NF characteristic is also improved.

As a gain characteristic of a signal spectrum by providing no gain equalization function to the light amplifier on the transmitting side is corrected in both the Raman amplifier and the light amplifier on the receiving side, the performance of the gain characteristic required for both can be moderated.

In the above-mentioned exemplary embodiments, the light amplifier on the transmitting side 2 is used after the optical transmitter 1; however, this light amplifier does not have to be used. The light amplifier on the transmitting side 2 is arranged after the optical transmitter 1 and the light amplifier on the receiving side 5 is arranged before the optical receiver 6, however, arrangement in the invention is not limited to this, for example, an optical multiplexer may be also arranged after the optical transmitter 1, and an optical demultiplexer may be also arranged before the optical receiver 6.

Further, a method of controlling the light amplifiers 2 and 5 is also not limited and for example, the light amplifier may be also configured by one stage of amplifying elements (an EDFA part) (therefore, its NF characteristic is deteriorated), however, in the invention, the number of the amplifying elements in the light amplifier is not limited (the NF characteristic is further improved by arranging a gain equalizer between two amplifying elements).

Besides, in the above-mentioned exemplary embodiments, signal light in 40 channels in an L-band is inputted to the light amplifier; however, a signal waveband and the number of signals (channels) are not limited. Further, in the exemplary embodiments, DSF is estimated for a transmission line fiber; however, a type of the transmission line fiber is not limited.

Furthermore, in the exemplary embodiments, two waves of 1462 nm and 1505 nm are used for excitation light by the Raman amplifier, however, an excitation wavelength of Raman amplification and the number of excitation wavelengths are not limited, and they are suitably selected according to a frequency band of the system and an extent to which the variation caused by omitting a gain equalization function in the light amplifier on the transmitting side of gain characteristics of spectra of signals of each wavelength is corrected. That is, the excitation wavelength of the Raman amplification and the number of excitation wavelengths are selected so that a signal spectrum of light incident into the optical receiver 6 is finally flat by the correction of gain characteristics by the Raman amplifier 4 and the light amplifier on the receiving side 5.

According to the invention, as the gain of a signal spectrum output to the transmission line and including a wavelength characteristic of a few dB is corrected by Raman amplification, effect that the loss of the gain equalizer used in the light amplifier on the receiving side is reduced and the NF characteristic is improved is acquired. In addition, a gain equalizer in the light amplifier on the transmitting side can be removed, further, as the loss of the gain equalizer used in the light amplifier on the receiving side is reduced, its manufacture is facilitated, and the price of the light amplifier can be reduced.

The previous description of these embodiments is provided to enable a person skilled in the art to make and use the present invention. Moreover, various modifications to the embodiments will be readily apparent to those skilled in the art, and the generic principles and specific examples defined herein may be applied to other embodiments without the use of inventive faculty. Therefore, the present invention is not intended to be limited to the embodiments described herein but is to be accorded the widest scope as defined by the limitations of the claims and equivalents.

What is claimed is:

1. An optical transmission system comprising a Raman amplifier, wherein:
the Raman amplifier corrects the gain of a light signal by excitation light including light of at least one wavelength that reduces difference between a minimum value and a maximum value of the power spectral distribution of the input light signal.

2. The optical transmission system according to claim 1, wherein:
the wavelength of the excitation light includes a predetermined number of wavelengths which correspond to the vicinity of a local minimum point of the power spectral distribution of the input light signal and each gain of Raman amplification of which is in the vicinity of the local minimum point.

3. The optical transmission system according to claim 1, wherein:
the gain of the excitation light is selected according to the power of the light signal.

4. The optical transmission system according to claim 1, comprising:
a gain equalizer that equalizes the gain of a light signal before an optical receiver.

5. The optical transmission system according to claim 1, comprising:
a preamplifier provided with a gain equalization function; and
a controller that monitors the light signal and controls the Raman amplifier or the preamplifier according to the result of monitoring.

6. The optical transmission system according to claim 1, comprising:
an optical transmission that transmits the light signal; and
an optical receiver that receives the light signal.

7. A Raman amplifier that amplifies an input light signal, wherein:
the Raman amplifier corrects the gain of the light signal by excitation light including light of at least one wavelength that reduces difference between a minimum value and a maximum value of the power spectral distribution of the input light signal.

8. The Raman amplifier according to claim 7, wherein:
the wavelength of the excitation light includes a predetermined number of wavelengths which correspond to the vicinity of a local minimum point of the power spectral distribution of the input light signal and each gain of Raman amplification of which is in the vicinity of the local minimum point.

9. The Raman amplifier according to claim 7, wherein:
the gain of the excitation light is selected according to the power of the light signal.

10. A method of correcting a signal spectrum in an optical transmission system provided with a Raman amplifier, wherein:
Raman amplification is produced by excitation light including at least one wavelength that reduces difference between a minimum value and a maximum value of the power spectral distribution of an input light signal.

11. The correcting method according to claim 10, wherein:
the wavelength of the excitation light includes a predetermined number of wavelengths which correspond to the vicinity of a local minimum point of the power spectral distribution of the input light signal and each gain of Raman amplification of which is in the vicinity of the local minimum point.

12. The correcting method according to claim 10, wherein:
the gain of the excitation light is selected according to the power of the light signal.

13. The correcting method according to claim 10, wherein:
the gain of a light signal is equalized prior to input to an optical receiver.

14. The correcting method according to claim 10, wherein:
a preamplifier equalizes the gain of an input light signal; and
the light signal is monitored and the Raman amplifier or the preamplifier is controlled according to the result of monitoring.
